(19) United States
(12) Patent Application Publication
(10) Pub. No.: US 2021/0050715 A1
(43) Pub. Date: Feb. 18, 2021

(54) WIRE ORGANIZATION APPARATUS AND METHOD

(71) Applicant: William C. Dyal, Savannah, GA (US)

(72) Inventor: William C. Dyal, Savannah, GA (US)

(21) Appl. No.: 16/504,462

(22) Filed: Jul. 8, 2019

Related U.S. Application Data
(63) Continuation-in-part of application No. 15/954,319, filed on Apr. 16, 2018, now abandoned.

(51) Int. Cl. H02B 1/30

(52) U.S. Cl. CPC H02B 1/306; F16L 3/2235

(57) ABSTRACT

Devices and methods help organize the process of connecting wires within an electrical enclosure. The device comprises an elongated body including a structure for temporarily attaching the elongated body to a side of the electrical panel enclosure such that the elongated body is vertically oriented when temporarily attached. A plurality of spaced apart projections extending outwardly from the elongated body, such that gaps are formed between adjacent projections, whereby unconnected wires entering into the electrical panel are sorted and temporarily placed into the gaps according to wire type, then removed from the gaps after sorting for making electrical connections within the panel. The devices may be attached mechanically, frictionally or magnetically. The elongated body has at least four spaced apart projections creating three gaps, including a first gap designated for bare ground wires, a second gap designated for white-jacketed neutral wires, and a third gap for black-jacketed hot wires.

### REFERENCE TO RELATED APPLICATIONS

This application is a continuation-in-part of U.S. patent application Ser. No. 15/954,319, filed Apr. 16, 2018, the entire content of which is incorporated herein by reference.

### FIELD OF THE INVENTION

This invention relates generally to residential and commercial electrical power distribution panels and enclosures, and more particularly, to an apparatus and method for organizing the wires within such panels and enclosures.

### BACKGROUND OF THE INVENTION

Circuit breaker panels are used to protect electrical circuitry from damage due to an overcurrent condition, such as an overload, a relatively high level short circuit, or a ground fault condition. To perform that function, circuit breaker panels include circuit breakers that typically contain a switch unit and a trip unit. The switch unit is coupled to the electrical circuitry (i.e., lines and loads) such that it can open or close the electrical path of the electrical circuitry. The switch unit includes a pair of separable contacts per phase, a pivoting contact arm per phase, an operating mechanism, and an operating handle.

Switchgear and switchboard are general terms used to refer to electrical equipment including metal enclosures that house switching and interrupting devices such as fuses, circuit breakers and relays, along with associated control, instrumentation and metering devices. The enclosures also typically include devices such as bus bars, inner connections and supporting structures (referred to generally herein as “panels” or “panelboards”) used for the distribution of electrical power.

Special panel boards and enclosures are typically utilized for systems permitting remote operation of circuit breakers. Specifically, panels are extended in length in order to accommodate a control unit. For example, a special panel may be constructed having an end that is extended to fit the panel control unit. Such a design precludes retrofitting standard panels and enclosures for use with remote-operated circuit breakers.

As such, circuit breakers and panels organize many high voltage wires. There is therefore presently a need for better organization of the wires within the electrical panel for neater and faster installations of breakers and panel wiring. The method and system must be robust enough to withstand the high ambient noise levels inherent in power distribution systems, and must be highly reliable. Unnecessary cost should be minimized.

The prior art has put forth several concepts of related designs. Among these are:

U.S. Pat. No. 3,588,620 to Wasileski describes an electrical control device panel assembly with multifunctional insulating support.

U.S. Pat. No. 4,006,324 to Sheppard describes an electrical distribution panel lockout means for switch actuators.

U.S. Pat. No. 7,403,373 to McCoy describes a circuit breaker mounting plate that can comprise a prong adapted to receive a clip.

U.S. Pat. No. 7,907,388 to DeBoer et al. describes a panel layout for an integrated power distribution system.

U.S. Pat. No. 7,995,314 to Titus describes devices, systems, and methods for managing a circuit breaker.

The foregoing prior art does not teach or suggest the present invention.

### SUMMARY OF THE INVENTION

This invention resides in a device and method for organizing the process of connecting wires within an electrical enclosure having right and left vertical side panels with flanges having front-facing surfaces. The device comprises an elongated body including a structure for temporarily attaching the elongated body to a side of the electrical panel enclosure such that the elongated body is vertically oriented when temporarily attached. A plurality of spaced apart projections extending outwardly from the elongated body, such that gaps are formed between adjacent projections, whereby unconnected wires entering into the electrical panel are sorted and temporarily placed into the gaps according to wire type, then removed from the gaps after sorting for making electrical connections within the panel.

In the preferred embodiment, the elongated body has at least four spaced apart projections creating three gaps, including a first gap designated for bare ground wires, a second gap designated for white-jacketed neutral wires, and a third gap for black-jacketed hot wires. One or more additional projections may be provided for one or more additional gaps for the black-jacketed hot wires. The preferred embodiment includes a pair of the elongated bodies, one configured for temporary attachment to the right side of the electrical enclosure, and the other being adapted for temporary attachment to the right side of the electrical enclosure.

The projections may extend outwardly from the surface of each elongated body at an angle in the range of 15 and 90 degrees; more preferably the projections may extend outwardly and upwardly from the outer surface of the elongated body at an angle between 15 and 60 degrees. The structure for temporarily attaching the elongated body to a side of the electrical panel enclosure may include an elongated side slot in the elongated body configured to receive a side flange of the enclosure. The structure may further include one of more clamps for maintaining the device in position, or the elongated side slot may be less than the thickness of the side flange in the enclosure, such that the elongated body flexes to frictionally maintain the device in position on the flange. In accordance with a preferred embodiment, the elongated body includes one or more magnets to provide the temporary attachment.

A method of organizing the process of connecting black, white and bare wires within an electrical enclosure having right and left vertical side panels with flanges having front-facing surfaces, comprising the steps of:

providing the elongated body of claim 1;

temporarily attaching the elongated body to a side of the electrical panel enclosure such that the elongated body is vertically oriented when temporarily attached;

placing the black, white and bare wires into separate gaps between the projections extending from the elongated body;

selectively removing and connecting the bare wires to a ground bus within the enclosure;

selectively removing and connecting the white wires to a neutral bus within the enclosure; and

selectively removing and connecting the black wires to circuit breakers within the enclosure.

The method may further include the steps of providing and temporarily attaching two of the elongated bodies to opposing sides of the electrical panel enclosure, or providing and temporarily attaching four of the elongated bodies to the electrical panel enclosure, with two above one another on each side for larger commercial or industrial load centers. In all cases, the black, white and bare wires are temporarily placed into separate gaps between the projections extending from the elongated bodies, then selectively removed for connection to the various buses and breakers within the box.

### BRIEF DESCRIPTION OF THE DRAWINGS

FIG. 1 is a schematic drawing that depicts a typical residential circuit breaker panel or “load center” to which the invention is applicable;

FIG. 2 shows unsorted, unconnected wires coming into the panel of FIG. 1;

FIG. 3 is a simplified drawing of a wire sorting device according to the invention;

FIG. 4 is a drawing that shows black, white and bare metal wires temporarily placed into gaps between projection in the device of FIG. 3;

FIG. 5 shows a device in the form of a metal lattice;

FIG. 6 illustrates an alternative device with a U-shaped slot for temporary attachment to an electrical enclosure;

FIG. 7 depicts an alternative embodiment made from a single piece of bent plastic;

FIG. 8 is one embodiment that uses magnetic attachment; and

FIG. 9 shows a further magnetically attached embodiment.

### DETAILED DESCRIPTION OF THE PREFERRED EMBODIMENTS

The present invention, briefly described, provides for an organization system for electrical wires in an electrical panel or bus station. The device allows for expedited installation of breakers and can be installed retroactively. It also does not require excessive hardware or fasteners for installation.

The present invention has many advantages over the prior art. This includes, but is not limited to: 1) improved convenience and ease of use; 2) improved organization and safety; 3) improved efficiency for installation of breakers or wire identification; 4) improved installation of the organizer without unnecessary hardware; and, 5) reduced confusion or instance of shortages or grounding at undesired location.

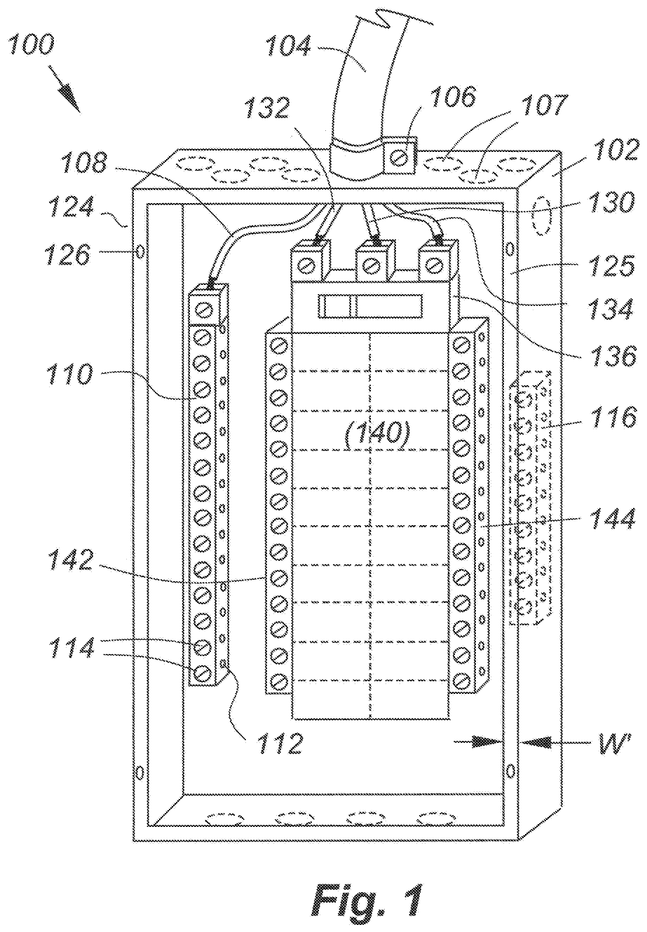

FIG. 1 is a drawing that shows a typical electrical circuit breaker panel 100 prior to individual circuit wiring. The panel includes a metal enclosure 102 having a height of about 24-36″, a width of about 12 to 24″, and a depth on the order of 3 to 5 inches. The panel box typically includes a peripheral flange 124, 125 with holes 126 to receive threaded fasteners for mounting a cover plate (not shown) over the box. Typically the front surface of peripheral flange 124, 125 is generally flush with surrounding wallboard material such as sheetrock, such that when the cover is fastened down, it rests against this surrounding material.

A main power line 104 comes into the box 102 through one of many “knock-outs” 106 on the top, sides and bottom of the enclosure. The main line and other wires entering the box are usually secured with cable clamps 106. The main line 104, typically 220 volts, includes a solid or stranded ground wire 108 connected to a first ground bus bar 110 including side holes 112 adapted to receive ground wires which are tightened down using set screws 114. Ground bus bar 110 is electrically connected to the metal of the enclosure itself which, in turn, may make electrical connection to one or more secondary ground bus bars 116, also with side through-holes and sets screws.

The main line includes a central neutral wire 130 and hot lines 132, 134. In a typical installation the voltage across lines 132, 134 is approximately 220 volts, whereas the voltage across either line 132, 134 and neutral wire 130 is 110 volts, more or less. Note that the wires of main line 104 may be copper or aluminum.

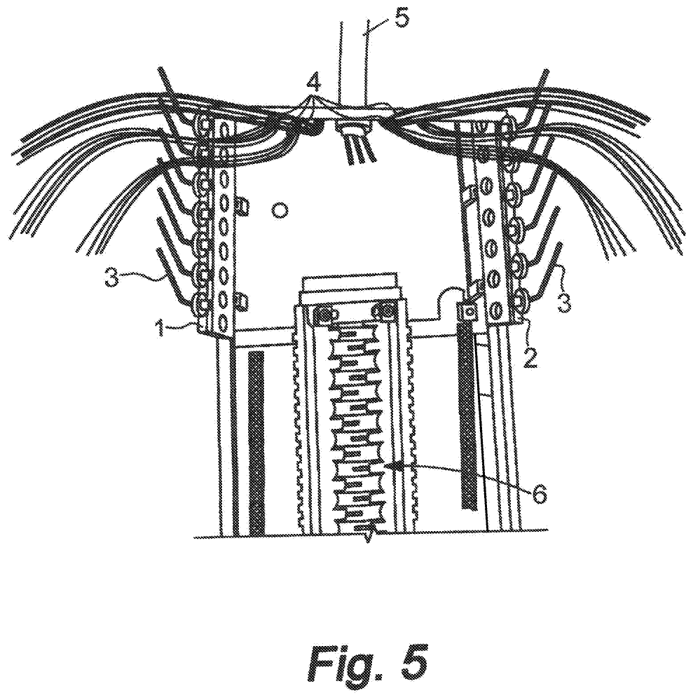

Hot wires 132, 134 feed interleaved electrical conductors (See FIG. 5) through a main breaker 136 to an area 140 wherein individual circuit breakers (also not shown), clip into the interleaved conductor structure. Neutral line 130 connects to neutral bus bars 142, 144 on both sides of the breaker area 140. The meandering conductor structure is such that 220V breakers mechanically contact “hot” lines 132, 134, whereas 110V volt breakers connect between 132 and 130 or 134 and 130.

All of the above is well known to licensed electricians. Further, this invention is not limited in terms of enclosure dimensions, and may be used with enclosures of any size, including smaller and older panels, including fuse panels. While a typical residential breaker panel or “load center” of the type shown in FIG. 1 includes certain bus bars and locations, the invention is also applicable to commercial load centers which may include different bus bar locations and many more breaker slots. The invention may not only be used with 220 and 110V breakers, but also accommodates specialized breakers such as ground-fault and arc-fault types

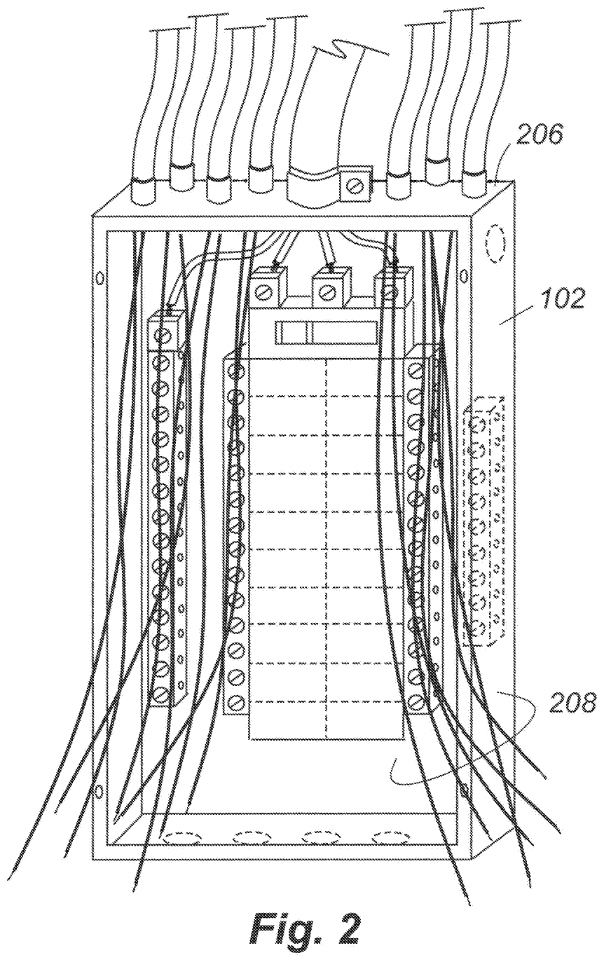

FIG. 2 is a simplified drawing that shows individual circuit wires 200 brought into enclosure 102 through cut-outs at the top of the box. The plastic jacketed wires 200, i.e., “Romex,” are usually stripped up to the inner surface of top panel 206, leaving individual strands 208. While only black wires are drawn, it is understood that the stripped cables include at least three different types of wires, namely, bare copper ground wires configured for connection to ground bus bars 110, 116; white insulated neutral wires that connect to neutral bus bars 142, 144, and black insulated wires that connect to the breakers when installed. On occasion some white wires may be “hot,” and there may be wires with other colors such as red but that is not critically important to the invention.

It will be appreciated from FIG. 2 that with dozens of wires entering into enclosure 102 from the top and potentially from other walls of the box, the result is often an entangled mess. This invention assists with sorting out this entanglement, and regiments the process of connecting the various wires to the correct bus bars and breakers.

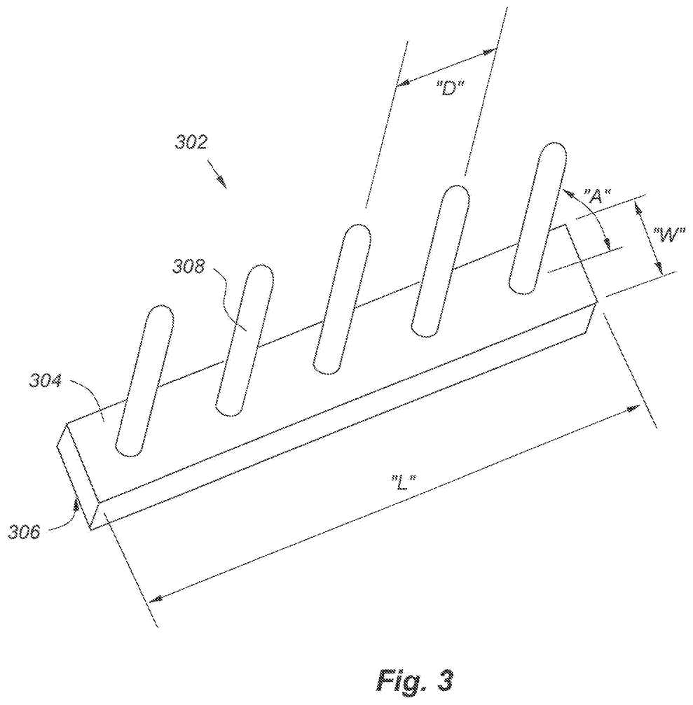

As shown in FIG. 3, the invention is broadly directed to a device 302 adapted for mounting onto the sides of the enclosure depicted in FIG. 1. The device 302 includes an elongated base plate 304 defining a plane from which a plurality of prongs 308 extend outwardly and at an angle “A” therefrom. The device may be constructed of any strong and rigid or semi-rigid material including metals, plastics, and combinations thereof.

In the preferred embodiments, the device 302 has bottom surface 306 adapted for temporary, removable mounting against the outer side edges 124, 126 of the enclosure 100. Different attachment techniques are described below. The prongs 308 have a length in the range of 2 to 5 inches, more preferably in the range of 3 to 4 inches. The spacing “D” between the prongs 308 may be in the range of 1 to 5 inches, more preferably in the range of 3 to 4 inches. The angle “A” may be in the range of 30 to 90 degrees, more preferably 40 to 50 degrees, and most preferably 45 degrees. The width “W” of the device may be in the range of ½″ to 1 inch or more, but is preferably about ½″ to match the width W′ of the outwardly facing lip surfaces of the enclosure 100. The cross-sectional size and shape of the prongs or posts 308 is of little consequence, but sharp edge should be avoided. Thus, cylindrical prongs with rounded tips will suffice.

The device 302 may come in different lengths “L” with different numbers of prongs for different applications. For example, for residential applications, the device 302 may have a length of 12 to 18 inches with 3 to 5 prongs, more preferably 4 prongs as described in further detail below. For commercial or industrial applications, which use taller enclosures with 84 or more breakers, the device 302 may be 24 to 30 inches in length, with 8 to 12 prongs, more or less. As an alternative to providing two different products for the two applications, however, two of the same shorter, residential devices may simply be used above one another on each side of a taller commercial or industrial enclosure box.

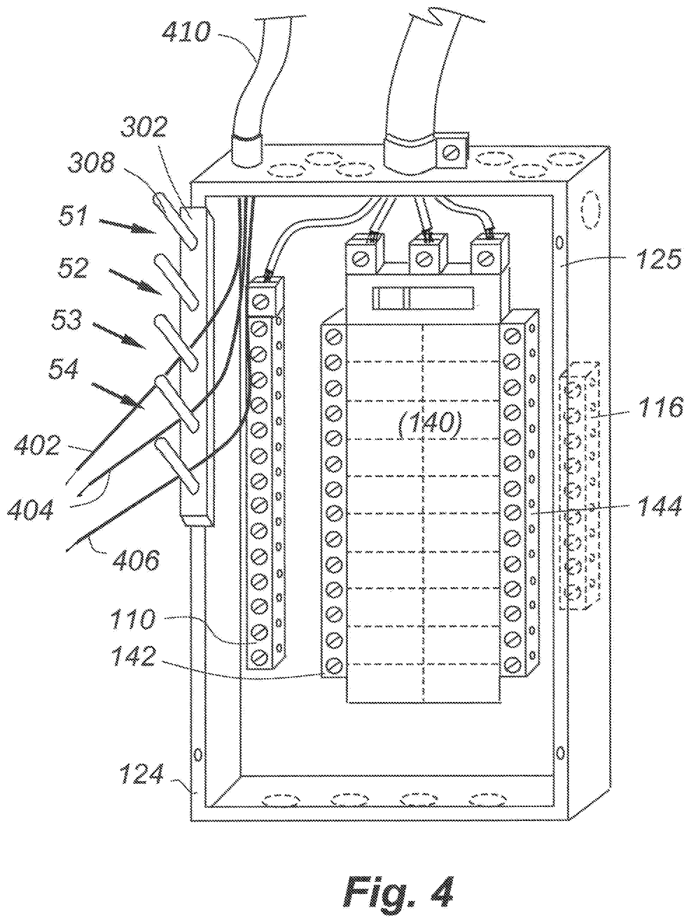

FIG. 4 shows one of the devices 302 mounted one side of enclosure 100 against outwardly facing left flange surface 124 with the understanding that in practice, another one of the devices would be mounted on the right onto flange surface 125. FIG. 4 also only shows the wires 402, 404, 406 associated with one incoming cable 410 for the sake of clarity, with the understanding that the same procedures to be described would be used for many additional cables. While device 302 may be positioned anywhere on surfaces 124, 125, in practice it is desirable to place the device toward to top so that wires such as 402, 404, 406 are redirected as soon as possible away from the enclosure to provide for an uncluttered work space.

Device 302 in FIG. 4 has 5 prongs 308 establishing four slots S1, S2, S3, S4. Wire 402 is black or ‘hot’, wire 404 is white or neutral, and wire 406 is a bare (copper) ground wire. While a user may use the slots in any manner convenient to them, the invention anticipates the lowest slot S4 to hold ground wires, the next slot up S3 to hold white neutral wires, and the upper slot(s) to hold black hot wires. As such, device 302 really only requires at least 4 prongs to establish 3 slots. However, as discussed below, it may be advantageous to provide multiple upper slots for the hot wires, as they are often labeled and are often required to connect to specific breakers at specific locations, whereas the ground and neutral wires may essentially connect to any positions on their respective buses. It is also convenient to place the ground wires at the lowest level, as they will ordinarily be removed first and pushed toward the back of the enclosure with the neutral and hot wires covering them.

Continuing the reference to FIG. 4, a user might group all of the bare ground wires to slot S4. The same procedure would be used on the right side of the enclosure using a separate device mounted on the right side (not shown). Basically the ground wires would be dressed into the slots S4 on both sides to achieve the cleanest routing of wires coming in from the right or left, whether from the top, sides or bottom of the panel while avoiding wires crossing over in front of the breaker area. The same procedure would be used for the white/neutral wires, grouping them in slots s3 on both sides of the enclosure. The hot black wires would be grouped in the top slot(s).

Once the various wires have been dressed through their respective slots, the user would begin removing the ground wires 406 from the lower slot, cutting them to length, and fastening them into ground buses 110, 116 to achieve an organized, functional appearance. Some electricians are very particular about the way in which their wires are routed, and this invention assists with that goal.

After the ground wires are routed and connected on both sides, the white neutral wires are trimmed and connected to buses 142, 144. Following this, the invention gives the user options. According to one option, depending upon the number of hot wires, the user may simple remove the black wires from the upper slot(s) and connect them to their appropriate breakers. Optionally, however, since the lower slots are no longer unoccupied, the user may choose to repopulate all of the slots with the black wires to better organize the routing of the hot lines to specific breakers. When the wires have been connected on both sides, the user simply removes the device(s).

The devices 302 may assume different designs and different attachment mechanisms may be used. For example, as shown in FIG. 5, the device 302 may be comprised of a left metal lattice (1), a right metal lattice (2), and metal prongs (3) extending from both the left and right metal lattices (as depicted, there are seven on the left and six on the right). The drawing also shows clusters of wires organized according to the invention (three on the left, three on the right), incoming power cord (5) and circuit breaker interconnect structure (6).

Both the left metal lattice and the right metal lattice are composed of any structural material known in the art which can support the weight of the materials and the wires. Such structural materials include, but are not limited to metal, plastic and the like. Examples of structural metal materials include steel, aluminum, etc.

In the embodiment of FIG. 5, the left and right metal devices are mechanically secured with clamps. The prongs may also be secured to the lattices with clamps, for example. As discussed, the same color wires hook around the same metal prong. For example, all the copper-colored wires are grouped together and hook around the same metal prong whereas all the white-colored and black-colored wires are separately grouped together and hook around different metal prongs from those which hold the copper-colored wires.

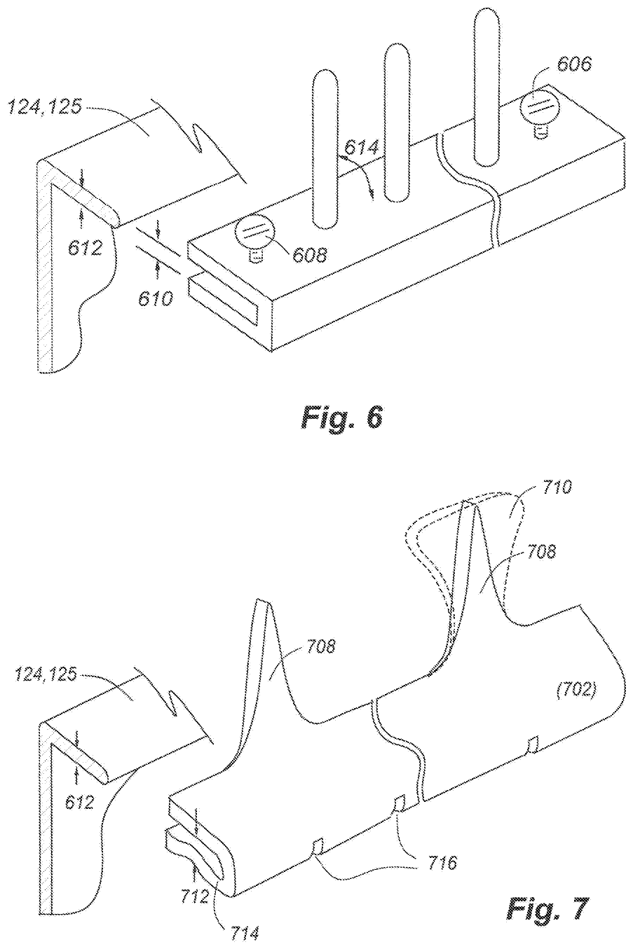

FIG. 6 illustrates a different construction which uses a U-shaped channel 602 having a gap 610 slightly wider than the gauge of the metal used to form the enclosure, such that the device may be slid onto the rim 124, 125 the enclosure from the inside and tightened down using one or more fasteners such as thumb screws 606, 608. In this design, the angle 614 between the posts and the elongated body may be ninety degrees so that the device may be used in the same fashion on both side of the enclosure.

FIG. 7 is a further embodiment made from bent plastic such as acrylic, obviating the need for injection molding. In this case, thermo-formed bent elongated strip 702 includes a gap portion 712 that is less than the thickness of the gauge of the metal used to form the enclosure, such that the device may slid onto the rim 124, 125 the enclosure from the inside and frictionally held in position. The lower panel 714 may include separations to ease with the flexing of the material and the installation process. Prongs 708 may simply be portions of the plastic bent upwardly. Again, post design is preferably used that allows the sane device to be temporarily installed on either side of the enclosure. As with all embodiments disclosed herein, posts 710 that fan out from the base material may alternatively be used.

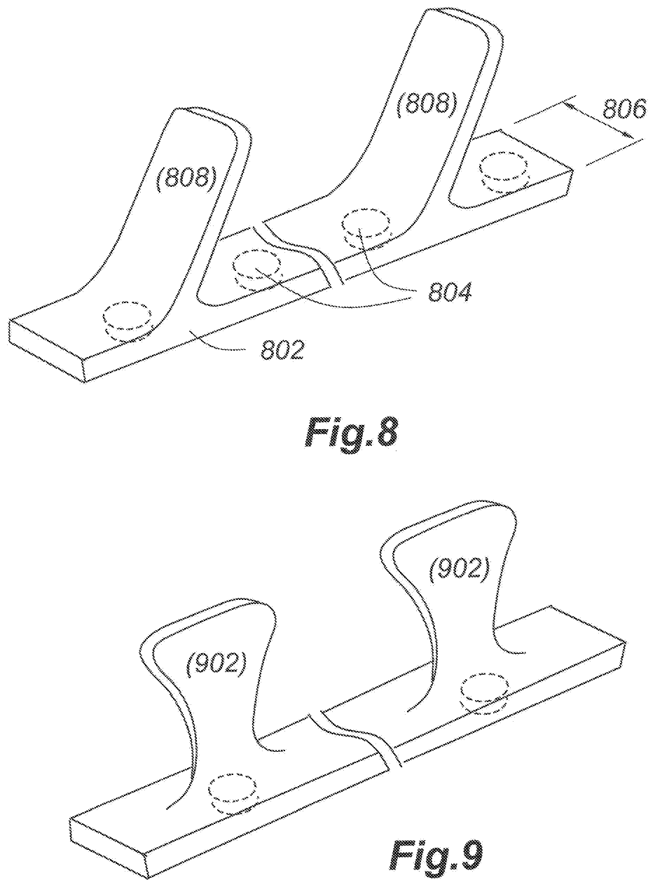

FIG. 8 illustrates a preferred embodiment of the invention that uses magnetic attachment. The device comprises a plastic or non-magnetic metal body 802 including prongs 808 that me be at any angle, including 90 degrees, as the same device inherently may be used on either side of the enclosure. Attached to, or preferably within body 802 are one or more magnets 804 facilitating the temporary attachment to the outwardly facing rims 124, 125 of the enclosure. While a strip of magnetic material may be used, it may not provide reliable attachment, so more preferably this embodiment uses a plurality of rare-earth (i.e., neodymium) cylindrical magnets glued in/on or press-fit into the body 802. Body may be injection molded of 3-D printed, with a width preferably on the order of ½ to ¾″ to match the width of enclosure rims 124, 125. FIG. 9 shows a magnetically attached embodiment with alternative posts in the shape of fins 902.

While the invention has been described in connection with what are considered to be exemplary embodiments, it is to be understood that the invention is not limited to the disclosed embodiments, but on the contrary, is intended to cover various modifications and equivalent arrangements included within the spirit and scope of the appended claims.

1. A device for organizing the process of connecting wires within an electrical enclosure having right and left vertical side panels with flanges having front-facing surfaces, the device comprising:
an elongated body;
wherein the elongated body includes a structure for temporarily attaching the elongated body to a side of the electrical panel enclosure such that the elongated body is vertically oriented when temporarily attached; and
a plurality of spaced apart projections extending outwardly from the elongated body, the projections having a length and a spacing in range of 1 to 5 inches, such that gaps are formed between adjacent projections;
whereby unconnected wires entering into the electrical panel are sorted and temporarily placed into the gaps according to wire type, then removed from the gaps after sorting for making electrical connections within the panel.

2. The device of claim 1, wherein each elongated body has at least four spaced apart projections creating three gaps, including a first gap designated for bare ground wires, a second gap designated for white-jacketed neutral wires, and a third gap for black-jacketed hot wires.

3. The device of claim 2, further including one or more additional projections forming one or more additional gaps for the black-jacketed hot wires.

4. The device of claim 1, including a pair of the elongated bodies, one configured for temporary attachment to the right side of the electrical enclosure, and the other being adapted for temporary attachment to the right side of the electrical enclosure.

5. The device of claim 1, wherein:
the elongated body includes an outer surface; and
the projections extend outwardly from the surface at an angle between 15 and 90 degrees.

6. The device of claim 1, wherein:
the elongated body includes an outer surface; and
the projections extend outwardly and upwardly from the surface at an angle between 15 and 60 degrees.

7. The device of claim 1, wherein the structure for temporarily attaching the elongated body to a side of the electrical panel enclosure includes an elongated side slot in the elongated body configured to receive a side flange of the enclosure.

8. The device of claim 7, wherein the elongated side slot in the elongated body is greater than the thickness of the side flange in the enclosure, and the structure further includes one of more clamps for maintaining the device in position.

9. The device of claim 7, wherein a portion of the elongated side slot in the elongated body is less than the thickness of the side flange in the enclosure, such that the elongated body flexes to frictionally maintain the device in position on the flange.

10. The device of claim 1, wherein the structure for temporarily attaching the elongated body to a side of the electrical panel enclosure includes one or more magnets.

11. A method of organizing the process of connecting black, white and bare wires within an electrical enclosure having right and left vertical side panels with flanges having front-facing surfaces, comprising the steps of:
providing the elongated body of claim 1;
temporarily attaching the elongated body to a side of the electrical panel enclosure such that the elongated body is vertically oriented when temporarily attached;
placing the black, white and bare wires into separate gaps between the projections extending from the elongated body;
selectively removing and connecting the bare wires to a ground bus within the enclosure;
selectively removing and connecting the white wires to a neutral bus within the enclosure; and
selectively removing and connecting the black wires to circuit breakers within the enclosure.

12. The method of claim 11, including the steps of:
providing and temporarily attaching two of the elongated bodies to opposing sides of the electrical panel enclosure;
placing the black, white and bare wires into separate gaps between the projections extending from both of the elongated bodies; and
selectively removing and connecting the wires from the gaps on both sides.

13. The method of claim 11, including the steps of:
providing and temporarily attaching four of the elongated bodies to the electrical panel enclosure, with two above one another on each side;
placing the black, white and bare wires into separate gaps between the projections extending from all of the elongated bodies; and
selectively removing and connecting the wires from all four of the bodies on both sides of the enclosure.
